(19) United States
(12) Patent Application Publication
(10) Pub. No.: US 2026/0239512 A1
(43) Pub. Date: Aug. 13, 2026

(54) GRANTING ACCESS TO CONTROL A LIGHTING DEVICE IN DEPENDENCE ON A DOOR STATUS

(71) Applicant: SIGNIFY HOLDING B.V., EINDHOVEN (NL)

(72) Inventors: FETZE PIJLMAN, EINDHOVEN (NL); DZMITRY VIKTOROVICH ALIAKSEYEU, EINDHOVEN (NL); JAN EKKEL, OSS (NL)

(21) Appl. No.: 19/156,966

(22) PCT Filed: Feb. 13, 2024
(86) PCT No.: PCT/EP2024/053545

§ 371 Date: Aug. 15, 2025

(30) Foreign Application Priority Data
Mar. 2, 2023 (EP) 23159658.6

(51) Int. Cl. H05B 47/115; F21V 23/04; H05B 47/175

(52) U.S. Cl. CPC H05B 47/115; F21V 23/0435; F21V 23/0471; H05B 47/1965; H05B 47/1995

(57) ABSTRACT

A system (1) for controlling access to a lighting device (32) in a room (42) is configured to receive, from a door sensor (15), a sensor signal indicative of a door status which indicates whether a door (62) to the room is open or closed, grant a first set of a plurality of users (51,52) access to control at least a first function of the lighting device while the door is detected to be open, grant a second set of one or more users (52) access to control at least the first function of the lighting device while the door is detected to be closed, and deny one or more other users (51) of the first set access to control at least the first function of the lighting device while the door is detected to be closed. The second set is a subset of the first set.

### FIELD OF THE INVENTION

The invention relates to a system for controlling access to one or more lighting devices.

The invention further relates to a method of controlling access to one or more lighting devices.

The invention also relates to a computer program product enabling a computer system to perform such a method.

### BACKGROUND OF THE INVENTION

In many lighting systems targeted towards consumers, all users that are authorized (and their user devices) can control all lighting devices in the lighting system. For example, in the current Hue lighting system, multiple mobile devices can be paired with the Hue bridge and each paired mobile device can control all lighting devices without restrictions. This is not always desirable, especially if multiple persons that are not part of the same family use the same lighting system, e.g. in a student house/dorm.

If such a lighting system would be improved with basic access control, i.e. to allow an administrator to configure different access rights for different users with respect to one or more lighting devices, this improved lighting system would not be smart enough to cater for the different needs of the users at different moments. For example, if only the person whose bed is located in a certain bedroom is granted access to control the lighting device(s) in that bedroom, this does not consider that there may be circumstances when it is desirable to let another user control the lighting device(s) in that bedroom.

U.S. 20130214898 A1 discloses a user's device which transmits both door and user identification to a remote server, where the decision is made whether to open the door.

The permissions relating to doors or other physical assets may also be used to grant access to logical assets.

### SUMMARY OF THE INVENTION

It is a first object of the invention to provide a system, which can grant access to a lighting device in dependence on user identity while taking into account current circumstances.

It is a second object of the invention to provide a method, which can be used to grant access to a lighting device in dependence on user identity while taking into account current circumstances.

In a first aspect of the invention, a system for controlling access to one or more lighting devices comprises at least one input interface and at least one processor configured to receive, via said at least one input interface, a sensor signal from a door sensor indicative of a door status, said door status being indicative of whether a door to a room is detected to be open or closed, grant a first set of a plurality of users access to control at least a first function of said one or more lighting devices in said room while said door is detected to be open, and grant a second set of one or more users access to control at least said first function of said one or more lighting devices in said room while said door is detected to be closed, said second set being a subset of said first set, and deny one or more other users of said first set access to control at least said first function of said one or more lighting devices in said room while said door is detected to be closed.

This system makes it possible to grant more people access to control the lighting device(s) in the room when the door to the room is open than when the door is closed. This is done with the help of a door sensor. When the door is detected to be closed, a selected user (or a group of users) is granted access to control the lighting devices in the room. Only when the door is open, other users (e.g. all users of the lighting system or a subset thereof) are also granted access to control the lighting devices in the room.

For example, when the door to a bedroom is open, the person to whom this bedroom belongs may be assumed not to be present and/or not to mind being disturbed and other people may therefore be granted access to control the lighting device(s) in this bedroom. For example, a parent may be granted access to control the lighting device(s) in the bedroom of a child when the door to this bedroom is detected to be open so as to allow the parent to switch off the light in the bedroom from work when the child is at school or switch on the light in the bedroom when cleaning the room. Users may be granted access to switch on lights in public areas and their own private areas. This allows unrestricted control of living room lighting devices, for example.

Access is granted to control to at least a first function of the one or more lighting devices in the room. Access may be granted to all functions of the one or more lighting devices or only to a subset thereof. For example, other users may be granted access to switch off the light in a room of someone else while the door is detected to be closed but not to switch on the light in this room. By granting access to a user, the device of the user is also granted access. The door signal, which has been received from the door sensor, is indicative of the door status. The door sensor may, for example, be an open/close sensor, e.g. detecting electrical or mechanical contact, a camera, or a magnetic field sensor, e.g. a Hall effect sensor. In addition to one or more light sources, lighting devices may comprise one or more sensors.

Said at least one processor may be configured to allow or prevent a user device from controlling said one or more lighting devices in said room in dependence on an identifier of said user of said user device and said door status, said user device being allowed to control said one or more lighting devices if said identifier is included in a plurality of first identifiers of said first set of users and said door status indicates that said door is open or if said identifier is included in a plurality of second identifiers of said second set of users and said door status indicates that said door is closed.

This access control based on door status may be applied to all user devices of the user or only to certain, e.g. mobile, user devices of the user. As an example of the latter, a physical light control device associated with the user may be allowed to control the one or more lighting devices if the physical light control device is located in the room even if the user's identifier is not included in the plurality of second identifiers and the door status indicates that the door is closed.

Said system may further comprise at least one control interface and said at least one processor may be configured to forward, via said at least one control interface, a control command to at least one of said one or more lighting devices upon receiving said control command from said user device if said user device is allowed to control said one or more lighting devices. This is beneficial if the system implements its access control on received control commands, e.g. rather than in a control app (with user interface) running on the user device. The system may be a light bridge, for example.

Said at least one processor may be configured to determine whether said user device is connected to the same network as said system, allow said user device to control said one or more lighting devices in said room if said user device is determined to be connected to the same network as said system, and prevent said user device from controlling said one or more lighting devices in said room if said user device is determined to be connected to a different network than said system. This helps prevent that the lighting device(s) are controlled by hackers and/or by authorized users that are less likely to need to control the lighting device(s). Another way of preventing hackers from controlling the lighting device(s) involves the use of geofencing.

Said at least one processor may be configured to provide a user interface on said user device based on said identifier of said user and said door status, said user interface indicating that said user can control said one or more lighting devices and/or obtain information relating to said one or more lighting devices if said identifier is included in said plurality of first identifiers of said first set of users and said door status indicates that said door is open or if said identifier is included in said plurality of second identifiers of said second set of users and said door status indicates that said door is closed. In this way, lighting control may be hidden for users which are not in the second set of users while the door is detected to be closed. This may be used to prevent that a user presses a button only to be informed that the user does not have access to perform that function.

Said at least one processor may be configured to grant said first set of users access to obtain current status information of said one or more lighting devices in said room while said door is detected to be open, and grant said second set of one or more users access to obtain said current status information of said one or more lighting devices in said room while said door is detected to be closed and deny said one or more other users access to obtain said current status information of said one or more lighting devices in said room while said door is detected to be closed.

Thus, access control based on door status may not only be applied to controlling the lighting device(s) but also to obtaining information about the lighting device(s). The current status information may specify which lights are on/off and what scene is playing, for example. The one or more other users may be denied access to the current status information while the door is detected to be closed by denying them access to all status information, e.g. current status information and previous events, while the door is detected to be closed.

For instance, in a multi-person household (e.g. student house/dorm), a person may want to be able to privately switch the lights on in the middle of the night and not have information like light state and scene names made public to all users of the lighting system. Access control based on door status may not only be applied to controlling the lighting device(s) but also to controlling (e.g. configuring) one or more accessories, e.g. a motion sensor, in the room and to obtaining information about the one or more accessories, e.g. motion sensor state. One or more sensors may also be included in the lighting devices themselves. These one or more sensors may be used for a lighting and/or a security function, for example. For instance, a window being open and motions being triggered may also be considered private information. Alternatively, access control based on door status may be limited to controlling the light source(s) of the lighting device(s).

Said at least one processor may be configured to grant said first set of users access to obtain first event information on first events related to said one or more lighting devices in said room, said first events occurring while said door is detected to be open, and grant said second set of one or more users access to obtain second event information on second events related to said one or more lighting devices in said room and deny said one or more other users access to obtain said second event information, said second events occurring while said door is detected to be closed. The privacy of users may be protected by restricting access to current status information, as described above, but also by restricting access to previous events. For example, when a user played a certain light scene in his bedroom while the user's door was closed, the user may want to prevent that other users can see this information later when the door is open again.

Said at least one processor may be configured to prevent one or more automated routines from controlling said one or more lighting devices in said room while said door is detected to be closed. Said at least one processor may be configured to prevent all automated routines from controlling said one or more lighting devices in said room while said door is detected to be closed or prevent all automated routines not associated with anyone from said second set of users from controlling said one or more lighting devices in said room while said door is detected to be closed. For example, a light routine which mimics the presence of a person may be disabled while the door is detected to be closed and/or a wakeup routine or timer configured by another user than the primary user(s) associated with the room (i.e. the user(s) included in the second set of users) may disabled while the door is detected to be closed.

Said at least one processor may be configured to detect a local user device in proximity of said door, obtain an identifier of a user of said local user device, and store said identifier of said user in a memory in relation to said second set of users to include said user in said second set of users. This may be beneficial for flexible offices to grant someone using an office access to control the lighting device(s) in that office regardless of whether the door is open or closed.

Said at least one processor may be configured to grant said first set of users access to control at least said first function of said one or more lighting devices in said room while said door is detected to be open and said door has been open for at least a predetermined amount of time, and deny said one or more other users of said first set access to control at least said first function of said one or more lighting devices in said room while said door is detected to be open and said door has not been open for at least said predetermined amount of time. This may be used to allow an occupant of a room to briefly leave the room, e.g. to get coffee or visit the restroom, without the risk of another user changing the light in the room in the meantime. The same principle may be used for obtaining current status information to avoid the risk of another using obtaining current status information while the user has briefly left the room.

Said at least one processor may be configured to detect whether a human is present in said room, grant said first set of users access to control at least said first function of said one or more lighting devices in said room while said door is detected to be closed and no human is detected to be present in said room, and deny said one or more other users of said first set access to control at least said first function of said one or more lighting devices in said room while said door is detected to be closed and a human is detected to be present in said room. This makes it possible to differentiate between a room being closed with someone inside and a room being closed with no one inside, which are different circumstances. If a room is closed with no one inside, it may be beneficial to grant other users access to control the lighting device(s) in that room. For example, a parent may be granted access when the door is detected to be open, or when the room is detected to be closed and no one is inside the room, so as to allow the parent to switch off the light in the bedroom from work when the child is at school.

Said at least one processor may be configured to store a group identifier of a group of users in a memory in relation to said second set of users to include all users of said group in said second set of users. This may be beneficial when multiple users share a room, for example. Users sharing a room may be included in the same group.

In a second aspect of the invention, a method of controlling access to one or more lighting devices comprises receiving a sensor signal from a door sensor indicative of a door status, said door status being indicative of whether a door to a room is detected to be open or closed, granting a first set of a plurality of users access to control at least a first function said one or more lighting devices in said room while said door is detected to be open, and granting a second set of one or more users access to control at least said first function of said one or more lighting devices in said room while said door is detected to be closed, said second set being a subset of said first set, and denying one or more other users of said first set access to control at least said first function of said one or more lighting devices in said room while said door is detected to be closed. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling access to one or more lighting devices.

The executable operations comprise receiving a sensor signal from a door sensor indicative of a door status, said door status being indicative of whether a door to a room is open or closed, granting a first set of a plurality of users access to control at least a first function said one or more lighting devices in said room while said door is detected to be open, and granting a second set of one or more users access to control at least said first function of said one or more lighting devices in said room while said door is detected to be closed, said second set being a subset of said first set, and denying one or more other users of said first set access to control at least said first function of said one or more lighting devices in said room while said door is detected to be closed.

As will be appreciated by one skilled in the art, aspects of the present invention may be embodied as a device, a method or a computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system;

FIG. 2 shows an example of a space in which the system of FIG. 1 is used;

FIG. 3 is a flow diagram of a first embodiment of the method;

FIG. 4 is a flow diagram of a second embodiment of the method;

FIG. 5 is a flow diagram of a third embodiment of the method;

FIG. 6 is a flow diagram of a fourth embodiment of the method;

FIG. 7 is a flow diagram of a fifth embodiment of the method;

FIG. 8 is a flow diagram of a sixth embodiment of the method;

FIG. 9 is a flow diagram of a seventh embodiment of the method;

FIG. 10 is a flow diagram of an eighth embodiment of the method;

FIG. 11 is a flow diagram of a ninth embodiment of the method; and

FIG. 12 is a block diagram of an exemplary data processing system for performing the method of the invention.

Corresponding elements in the drawings are denoted by the same reference numeral.

### DETAILED DESCRIPTION OF THE EMBODIMENTS

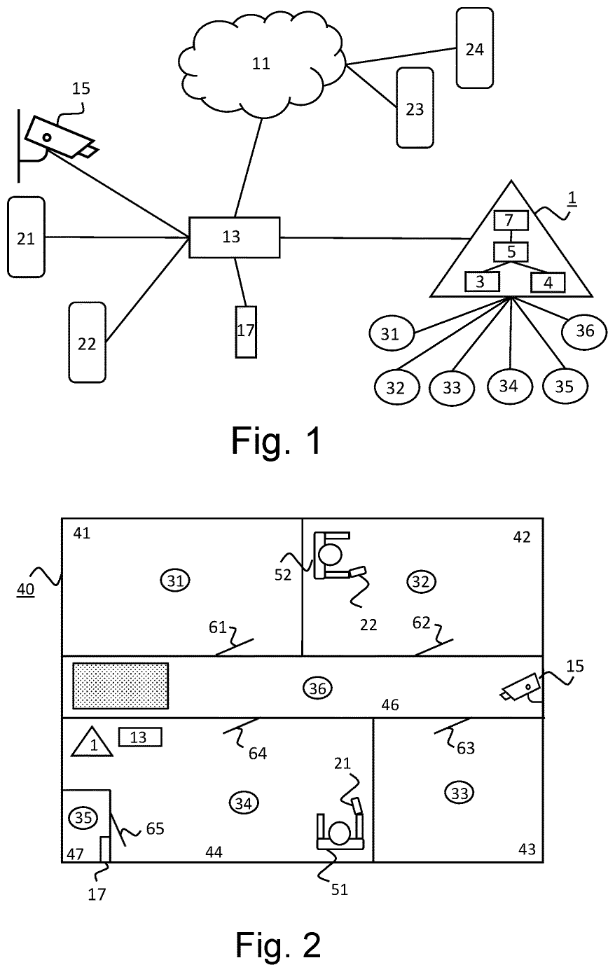

FIG. 1 shows an embodiment of the system for controlling access to one or more lighting devices. In this embodiment, the system is a light controller 1. The light controller 1 may be a Philips Hue bridge, for example. The light controller 1 is connected to a wireless LAN access point 13, e.g. via Ethernet or Wi-Fi. Door sensors 15 and 17 are also connected to the wireless LAN access point 13. The wireless LAN access point 13 is connected to the Internet 11. In an alternative embodiment, door sensors 15 and 17 communicate directly with the light controller 1, e.g. using Zigbee technology.

The light controller 1 is able to communicate with lighting devices 31-36, e.g. using Zigbee technology. Users of user devices 21-24 may be able to use an app running on their user device to control one or more of lighting devices 31-36 via the light controller 1. A user device may be, for example, a mobile device such as a mobile phone, a tablet or a smart watch. User devices 21-22 are connected directly to the wireless LAN access point 13 and are therefore local user devices. User devices 23-24 are connected to the Internet remotely, e.g. via an LTE or 5G mobile communication network, and are therefore remote user devices.

The light controller 1 comprises a receiver 3, a transmitter 4, a processor 5, and memory 7. The processor 5 is configured to receive, via the receiver 3, a sensor signal from door sensor 15 or 17 indicative of a door status. The door status is indicative of whether a door to a certain room is detected (by the door sensor 15 or 17) to be open or closed. The processor 5 is further configured to grant a first set of a plurality of users access to control at least a first function of one or more lighting devices in this room, e.g. one or more of lighting devices 31-36, while the door is detected to be open.

The processor 5 is further configured to grant a second set of one or more users access to control at least the first function of the one or more lighting devices in this room while the door is detected to be closed and deny one or more other users of the first set access to control at least the first function of the one or more lighting devices in this room while the door is detected to be closed. The second set is a subset of the first set.

In other words, when the door is detected to be closed, a selected user (or a group of users) is granted access to control the lighting devices in the room. Only when the door is open, other users (e.g. all users of the lighting system or a subset thereof) are also granted access to control the lighting devices in the room.

For example, when the door to a bedroom is open, the person to whom this bedroom belongs may be assumed not to be present and/or not to mind being disturbed and other people may therefore be granted access to control the lighting device(s) in this bedroom. For example, a parent may be granted access to control the lighting device(s) in the bedroom of a child when the door to this bedroom is detected to be open so as to allow the parent to switch off the light in the bedroom from work when the child is at school or switch on the light in the bedroom when cleaning the room. Users may be granted access to switch on lights in public areas and their own private areas. This allows unrestricted control of living room lighting devices, for example.

As another example, parents may include themselves in both the first set and second set of users and their child/children only in the first set of users in relation to a study room where a parent wants to do some focused work. Children elsewhere in the house cannot (accidently) change the lights when the door of the study room is closed. To configure this, the parents may include individual users and/or one or more groups of users in the first and second sets of user. For example, the parents may define a user group comprising the parents and a user group comprising the children. If all users of the lighting system are included in the first set of users, then no user input is necessary to include users in the first set.

It may not always be the person to whom the room belongs who is granted access to control the lighting device(s) in that room. For example, a child may be included in the first set of users but not in the second set of users with respect to the child's bedroom.

This may be useful to prevent that the child secretly reads a book at night. If the child closes the door, the child will not be able to turn the lights on; if the door is open then it is harder for the child to read a book without the parent(s) noticing.

Access control based on door status may not only be applied to controlling the lighting device(s) but also to obtaining information about the lighting device(s). For instance, in a multi-person household (e.g. student house/dorm), a person may want to be able to privately switch the lights on in the middle of the night and not have information like light state and scene names made public to all users of the lighting system. Access control based on door status may not only be applied to controlling the lighting device(s) but also to controlling one or more accessories, e.g. a motion sensor, in the room and to obtaining information about the one or more accessories, e.g. motion sensor state.

Access is granted to control to at least a first function of the one or more lighting devices in the room. Access may be granted to all functions of the one or more lighting devices or only to a subset thereof. For example, other users may be granted access to switch off the light in a room of someone else but to not switch on the light in this room. By granting access to a user, the device of the user is also granted access.

FIG. 2 shows an example of a space in which the light controller 1 of FIG. 1 is used. FIG. 2 shows a second floor 40 of a house. This second floor 40 has four rooms 41-44 and a hallway 46. Doors 61-64 connect rooms 41-44 to the hallway 46. Door sensor 15, see also FIG. 1, can be used to detect whether doors 61-64 are open or closed. Door sensor 15 comprises a camera.

Lighting device 31 of FIG. 1 is located in room 41, lighting device 32 of FIG. 1 is located in room 42, lighting device 33 of FIG. 1 is located in room 43, and lighting device 34 of FIG. 1 is located in room 44. Room 44 comprises a wardrobe 47. The lighting device 35 is located in this wardrobe 47. Lighting device 36 of FIG. 1 is located in hallway 46. The light controller 1 and the wireless LAN access point 13 are located in room 44.

In the example of FIG. 2, room 42 is the bedroom of user 52 and user 52 is included in the second set of users with respect to lighting device 32. User 51 of user device 21 and the users of user devices 23-24 are not included in this second set, but are included in the first set of users, along with user 52. As a result, only user 52 is able to control the first function, and optionally all functions, of the lighting device 32 when the door 62 is closed. User 51 and the users of user devices 23-24 are able to control the first function, and optionally all functions, of the lighting device 32 only when the door 62 is open.

In the example of FIG. 2, room 44 is the bedroom of user 51 and user 51 is included in the second set of users with respect to lighting device 34. User 52 of user device 22 and the users of user devices 23-24 are not included in this second set, but are included in the first set of users, along with user 51. As a result, only user 51 is able to control the first function, and optionally all functions, of the lighting device 34 when the door 64 is closed. User 52 and the users of user devices 23-24 are able to control the first function, and optionally all functions, of the lighting device 34 only when the door 64 is open.

The lighting device 35 is associated with the wardrobe 47 and not directly with the room 44. However, it may be possible to indirectly associate the lighting device 35 with the room 44. In this case, when the door 65 to the wardrobe 47 is detected to be open via door sensor 17, the wardrobe 47 becomes part of room 44 and the same users that are granted access to control the lighting device 34 are also granted access to control the lighting device 35. When the door 65 to the wardrobe 47 is closed, a subset of these users are granted access to control the lighting device 35. This subset has been defined in relation to the wardrobe 47 and may not be the same subset of users which are granted access to control lighting device 34 when door 64 is closed. The door sensor 17 may comprise an open/close sensor, e.g. detecting electrical or mechanical contact, or a magnetic field sensor, e.g. a Hall effect sensor, for example.

In the embodiment of FIG. 1 and/or in a variant thereof, the processor 5 is configured to allow or prevent one of user devices 21-24 from controlling the one or more lighting devices in the room in dependence on an identifier of the user of the user device and the door status. The user device is allowed to control the one or more lighting devices if the identifier is included in a plurality of first identifiers of the first set of users and the door status indicates that the door is open or if the identifier is included in a plurality of second identifiers of the second set of users and the door status indicates that the door is closed.

In the embodiment of FIG. 1 and/or in the variant thereof, the processor 5 may be configured to forward, via the transmitter 4, a control command to at least one of the one or more lighting devices upon receiving the control command from the user device if the user device is allowed to control the one or more lighting devices.

In the embodiment of FIG. 1 and/or in the variant thereof, the processor 5 may be configured to determine whether the user device is connected to the same network as the light controller 1, allow the user device to control the one or more lighting devices in the room if the user device is determined to be connected to the same network as the light controller 1, and prevent the user device from controlling the one or more lighting devices in the room if the user device is determined to be connected to a different network than the light controller 1. In the example of FIG. 1, user devices 21 and 22 are connected to the same network as light controller 1 and user devices 23 and 24 are not. Another way of preventing hackers from controlling the lighting devices involves the use of geofencing.

In the embodiment of FIG. 1 and/or in the variant thereof, the processor 5 may be configured to provide a user interface on the user device based on the identifier of the user and the door status. The user interface indicates that the user can control the one or more lighting devices and/or obtain information relating to the one or more lighting devices if the identifier is included in the plurality of first identifiers of the first set of users and the door status indicates that the door is open or if the identifier is included in the plurality of second identifiers of the second set of users and the door status indicates that the door is closed.

In the embodiment of the light controller 1 shown in FIG. 1, the light controller 1 comprises one processor 5. In an alternative embodiment, the light controller 1 comprises multiple processors. The processor 5 of the light controller 1 may be a general-purpose processor, e.g. ARM-based, or an application-specific processor. The processor 5 of the light controller 1 may run a Unix-based operating system for example. The memory 7 may comprise one or more memory units. The memory 7 may comprise one or more hard disks and/or solid-state memory, for example.

The receiver 3 and the transmitter 4 may use one or more wired or wireless communication technologies such as Zigbee to communicate with the lighting devices 31-36 and Ethernet to communicate with the wireless LAN access point 13, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The light controller 41 may comprise other components typical for a light controller such as a power connector. The invention may be implemented using a computer program running on one or more processors.

In the embodiment of FIG. 1, the system of the invention is a light controller. In an alternative embodiment, the system of the invention is a different device, e.g. a cloud computer (cluster). In the embodiment of FIG. 1, the system of the invention comprises a single device. In an alternative embodiment, the system of the invention comprises a plurality of devices, e.g. the light controller 1 and the door sensor(s) 15 and/or 17.

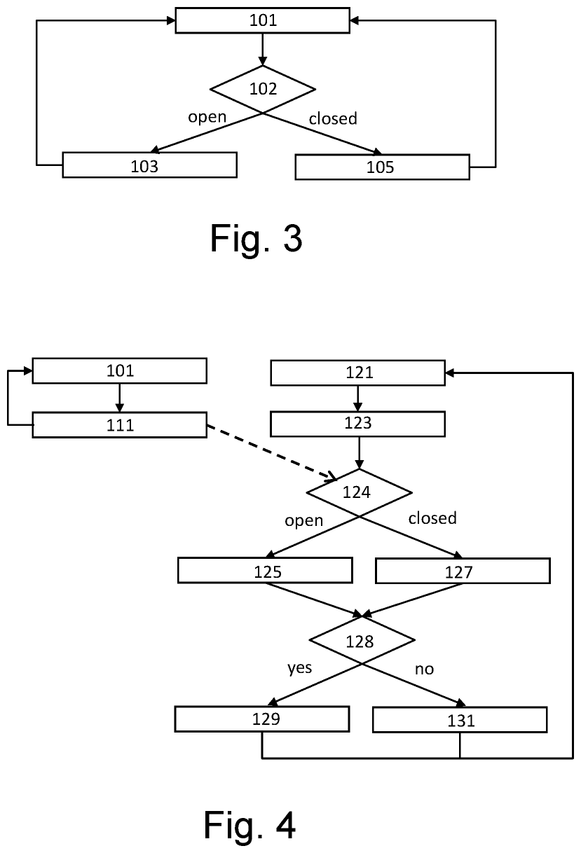

A first embodiment of the method of controlling access to one or more lighting devices is shown in FIG. 3. The method may be performed by the controller 1 of FIG. 1, for example. A step 101 comprises receiving a sensor signal from a door sensor. The sensor signal is indicative of a door status. The door status is indicative of whether a door to a room is open or closed. The one or more lighting devices are located in this room.

A step 102 comprises determining, based on this door status, whether the door is open or closed and performing a step 103 if the door is detected to be open and a step 105 if the door is detected to be open. Step 103 comprises granting a first set of a plurality of users access to control at least a first function of the one or more lighting devices in the room.

Step 105 comprises granting a second set of one or more users access to control at least the first function of the one or more lighting devices in the room. The second set is a subset of the first set. Step 105 further comprises denying one or more other users of the first set access to control at least the first function of the one or more lighting devices in the room.

These one or more lighting devices may comprise all lighting devices located in the room or a subset thereof. As an example of the latter, this access control based on door status may apply only to control of the functional lighting devices in the room and not to control of the decorative lighting devices in the room. Furthermore, the at least first function to which access is denied or granted may exclude decorative lighting functions, e.g. if a single lighting device has one or more light sources for decorative lighting and one or more light sources for functional lighting. Thus, the one or more other users of the first set may only be able to set the functional lighting in a room when the door is open and may always or never be able to set the decorative lighting in the room.

A door, when inside a building, typically divides two rooms. Normally, the access control based on door status would be applied only to control of lighting devices in one of these two rooms. An administrator may associate a door sensor with this room or with one or more lighting devices in this room.

If a room has multiple doors that lead outside of the room, step 103 may performed if at least one of these multiple doors is detected to be open and step 105 may be performed if all of these multiples doors are detected to be closed. The door status of these multiple doors may be indicated in a sensor signal from a single door sensor or in sensor signals from multiple door sensors.

Step 101 is repeated after step 103 or step 105 has been performed, and the method then proceeds as shown in FIG. 3. Additionally, one or more steps of one or more of the embodiments of FIGS. 4-11 may be added to the embodiment of FIG. 3.

A second embodiment of the method of controlling access to one or more lighting devices is shown in FIG. 4. The method may be performed by the controller 1 of FIG. 1, for example. The second embodiment of FIG. 4 is an extension of the first embodiment of FIG. 3.

Step 101 comprises receiving a sensor signal from a door sensor. The sensor signal is indicative of a door status. The door status is indicative of whether a door to a room is open or closed. The one or more lighting devices are located in this room. A step 111 comprises storing this door status in a memory. Step 101 is repeated after step 111, e.g. periodically or every time the door signal changes.

A step 121 comprises receiving a control command for a first function of a lighting device from a user device. A step 123 comprises determining an identifier of a user of the user device from which the control command is received. The user identifier may be included in, or transmitted along with, the control command.

A step 124 comprises determining, based on the latest door status stored in the memory in step 111, whether the door is open or closed and performing a step 125 if the door is detected to be open and a step 127 if the door is detected to be open. Step 125 comprises obtaining a plurality of first identifiers of a first set of users which is associated with at least the first function of the one or more lighting devices.

Step 127 comprises obtaining a plurality of second identifiers of a second set of users which is associated with at least the first function of the one or more lighting devices. The second set is a subset of the first set. The pluralities of user identifiers may be associated with one or more functions or with all functions of all lighting devices in the room or may be associated with one or more functions or with all functions of a subset of all lighting devices in the room.

A step 128 comprises determining whether the user identifier determined in step 123 is included in the plurality of user identifiers obtained in step 125 or 127, whichever was performed. A step 129 is performed if the user identifier is included in the plurality of user identifiers. A step 131 is performed otherwise.

Step 129 comprises allowing the user device to control the one or more lighting devices in the room by forwarding the control command received in step 121 to the one or more lighting devices. Step 131 comprises preventing the user device from controlling the one or more lighting devices in the room by not forwarding the control command received in step 121 to the one or more lighting devices. Step 121 is repeated after step 129 or step 131 has been performed, and the method then proceeds as shown in FIG. 4.

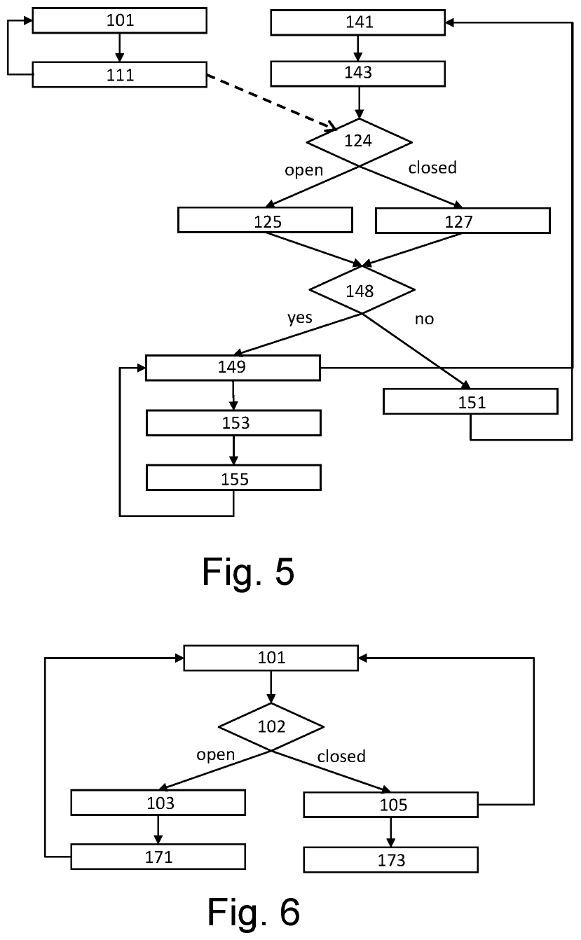

Thus, the first set of a plurality of users is granted access to control the first function the one or more lighting devices in the room while the door is detected to be open, the second set of one or more users is granted access to control the first function of the one or more lighting devices in the room while the door is detected to be closed, one or more other users of the first set are denied access to control the first function of the one or more lighting devices in the room while the door is detected to be closed, and one or more users not included in either set (if any) are denied access to control the first function of the one or more lighting devices in the room while the door is detected to be open. Additionally, one or more steps of one or more of the embodiments of FIGS. 5-11 may be added to the embodiment of FIG. 4.

A third embodiment of the method of controlling access to one or more lighting devices is shown in FIG. 5. The method may be performed by the controller 1 of FIG. 1, for example. The third embodiment of FIG. 5 is an extension of the first embodiment of FIG. 3.

Step 101 comprises receiving a sensor signal from a door sensor. The sensor signal is indicative of a door status. The door status is indicative of whether a door to a room is open or closed. The one or more lighting devices are located in this room. Step 111 comprises storing this door status in a memory. Step 101 is repeated after step 111, e.g. periodically or every time the door signal changes.

A step 141 comprises determining a user identifier associated with a user device. For example, this user identifier may configured in an app running on the user device and transmitted by the user device. A step 143 comprises determining whether user device is connected to a same network as the system which performs the method.

A step 124 comprises determining, based on the latest door status stored in the memory in step 111, whether the door is open or closed and performing step 125 if the door is detected to be open and step 127 if the door is detected to be open. Step 125 comprises obtaining a plurality of first identifiers of a first set of users which is associated with at least the first function of the one or more lighting devices.

Step 127 comprises obtaining a plurality of second identifiers of a second set of users which is associated with the one or more lighting devices. The second set is a subset of the first set. The pluralities of user identifiers may be associated with all lighting devices in a room or may be associated with a subset of all lighting devices in the room.

A step 128 comprises determining whether the user identifier determined in step 141 is included in the plurality of user identifiers obtained in step 125 or 127, whichever was performed, and whether it was determined in step 143 that the user device is connected to the same network as the system which performs the method. If so, a step 149 is performed. If not, a step 151 is performed.

Step 149 comprises providing, on the user device, a user interface which indicates that the user can control the one or more lighting devices and/or obtain information relating to the one or more lighting devices. Step 151 comprises providing, on the user device, a user interface which does not indicate that the user can control the one or more lighting devices and/or obtain information relating to the one or more lighting devices. The user interface provided in step 151 may indicate that the user can control other lighting devices and/or obtain information relating to other lighting devices, for example.

Steps 153 and 155 may be performed after step 149. Step 153 comprises receiving, via the user interface, user interaction for controlling at least one of the one or more lighting devices or obtaining information relating to at least one of the one or more lighting devices. Step 155 comprises controlling the at least one lighting device or obtaining information relating to the at least one lighting device. Step 149 may be repeated after step 155 has been performed, and the method then proceeds as shown in FIG. 5.

Step 141 may be repeated after step 149 or step 151 has been performed, e.g. if the door status changes, and the method then proceeds as shown in FIG. 5. Additionally, one or more steps of one or more of the embodiments of FIGS. 4, 6-11 may be added to the embodiment of FIG. 5. Steps 141-155 and steps 124-127 may be performed for multiple user devices, e.g. for each user device that is connected to the system that performs the method.

A fourth embodiment of the method of controlling access to one or more lighting devices is shown in FIG. 6. The method may be performed by the controller 1 of FIG. 1, for example. The fourth embodiment of FIG. 6 is an extension of the first embodiment of FIG. 3. In the embodiment of FIG. 6, a step 171 is performed after step 103 of FIG. 3 and a step 173 is performed after step 105 of FIG. 3.

Step 171 comprises granting the first set of users access to obtain current status information of the one or more lighting devices in the room. The current status information may specify which lights are on/off and what scene is playing, for example. Step 173 comprises granting the second set of one or more users access to obtain the current status information of the one or more lighting devices in the room and denying the one or more other users access to obtain the current status information of the one or more lighting devices in the room.

For example, a room definition in a lighting system may comprise an additional attribute when a door sensor is associated with this room. This attribute defines which users have access to the current status information in the room when the door is closed. In this case, all other users may be denied access to the current status information in the room when the door is closed. The advantage of this is that a user can discretely turn on the light in the middle of the night without other members in the house, e.g. a student house/dorm, being aware of it.

The one or more other users may be denied access to the current status information while the door is detected to be closed by denying them access to all status information, e.g. current status information and previous events, while the door is detected to be closed. Additionally, one or more steps of one or more of the embodiments of FIGS. 4-5,7-11 may be added to the embodiment of FIG. 6. Steps 103 and 171 may be combined into a single step. Steps 105 and 173 may also be combined into a single step.

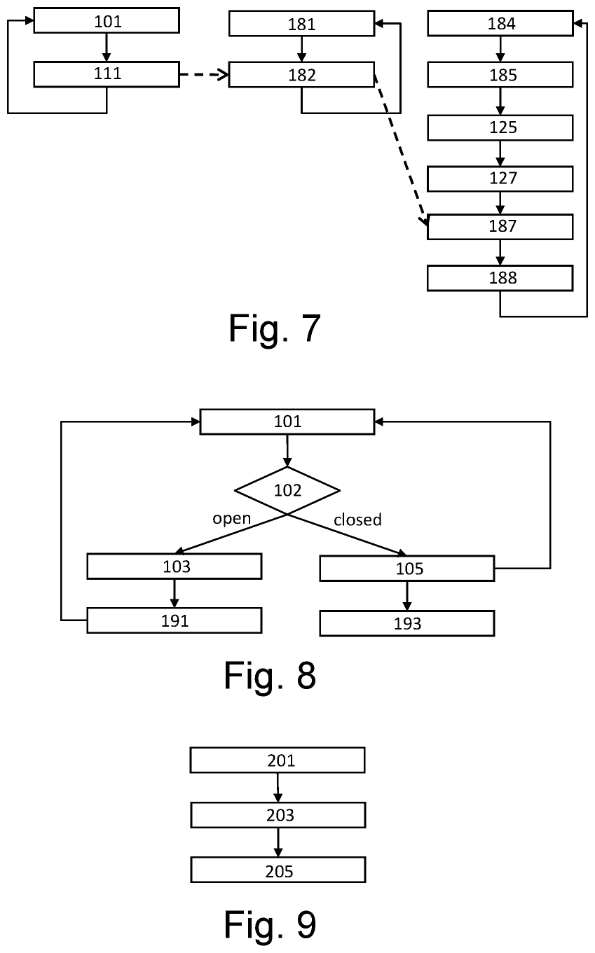

A fifth embodiment of the method of controlling access to one or more lighting devices is shown in FIG. 7. The method may be performed by the controller 1 of FIG. 1, for example. The fifth embodiment of FIG. 7 is an extension of the first embodiment of FIG. 3.

Step 101 comprises receiving a sensor signal from a door sensor. The sensor signal is indicative of a door status. The door status is indicative of whether a door to a room is open or closed. The one or more lighting devices are located in this room. Step 111 comprises storing this door status in a memory. Step 101 is repeated after step 111, e.g. periodically or every time the door signal changes.

A step 181 comprises obtaining event information on an event related to the one or more lighting devices. A step 182 comprises associating the event with the latest door status stored in the memory in step 111 and storing this association in the memory. Step 181 is repeated after step 182, e.g. each time a new event occurs. In an alternative embodiment, each event is associated with a date and time and each time interval is associated with a door status. Over multiple iterations, step 182 comprises storing first event information on first events which occur while the door is detected to be open and storing second event information on second events which occur while the door is detected to be closed.

A step 184 comprises receiving a user request for event information related to the one or more lighting devices, e.g. from a user device. The user request is indicative of the one or more lighting devices. A step 185 comprises determining an identifier of the user that made the request, e.g. of the user of the device from which a message with the request was received.

Step 125 comprises obtaining a plurality of first identifiers of a first set of users which is associated with the one or more lighting devices indicated in the user request received in step 184. Step 127 comprises obtaining a plurality of second identifiers of a second set of users which is associated with the one or more lighting devices indicated in the user request received in step 184. The second set is a subset of the first set.

Step 187 comprises compiling a customized event list for the user whose identifier was determined in step 185. If the identifier of this user is included the second identifiers obtained in step 127, the event list comprises the first event information and the second event information stored in step 182. If the identifier of this user is included in the first identifiers obtained in step 125 but not in the second identifiers obtained in step 127, the event list comprises the first event information stored in step 182 but not the second event information stored in step 182. A step 188 comprises providing the event list compiled in step 187 to the user (device).

Thus, in steps 185-188, the first set of users is granted access to obtain the first event information on the first events related to the one or more lighting devices in the room, the second set of one or more users is granted access to obtain the second event information on the second events related to the one or more lighting devices in the room, and the one or more other users of the first set are denied access to obtain the second event information. If the identifier of the user is not included in either the first identifiers or the second identifiers (if this is possible), an empty event list is provided in step 188. Additionally, one or more steps of one or more of the embodiments of FIGS. 4-6, 8-11 may be added to the embodiment of FIG. 7.

A sixth embodiment of the method of controlling access to one or more lighting devices is shown in FIG. 8. The method may be performed by the controller 1 of FIG. 1, for example. The sixth embodiment of FIG. 8 is an extension of the first embodiment of FIG. 3. In the embodiment of FIG. 8, a step 191 is performed after step 103 of FIG. 3 and a step 193 is performed after step 105 of FIG. 3.

Step 191 comprises allowing all automated routines to control the one or more lighting devices in the room. Examples of automated routines are wakeup routines and (regular) timers. Step 193 comprises preventing one or more automated routines from controlling the one or more lighting devices in the room. Step 193 may comprise preventing all automated routines from controlling the one or more lighting devices in the room.

Alternatively, step 193 may comprise preventing all automated routines not associated with anyone from the second set of users from controlling the one or more lighting devices in the room.

Additionally, one or more steps of one or more of the embodiments of FIGS. 4-7, 9-11 may be added to the embodiment of FIG. 8. Steps 103 and 191 may be combined into a single step. Steps 105 and 193 may also be combined into a single step.

A seventh embodiment of the method of controlling access to one or more lighting devices is shown in FIG. 9. The method may be performed by the controller 1 of FIG. 1, for example. The seventh embodiment of FIG. 9 is an extension of the first embodiment of FIG. 3.

A step 201 comprises detecting a local user device in proximity of the door. A step 203 comprises obtaining an identifier of a user of the local user device detected in step 201. A step 205 comprises storing the identifier of the user, as obtained in step 203, in a memory in relation to the second set of users to include the user in the second set of users.

This may be beneficial, for example, if the lighting system is used in a rent-out flex office. A user that enters the office may be granted access to the lighting system by holding their smartphone close to the door sensor. A wireless signal may enable authorization of the user to the system.

Steps 201-205 are performed before or in parallel to steps 101-105 of FIG. 3, which have not been duplicated in FIG. 9 for the sake of brevity. Additionally, one or more steps of one or more of the embodiments of FIGS. 4-8, 10 may be added to the embodiment of FIG. 9. For example, the identifier stored in step 205 may later be obtained as part of the second identifiers in step 127 of FIGS. 4, 5, and 7.

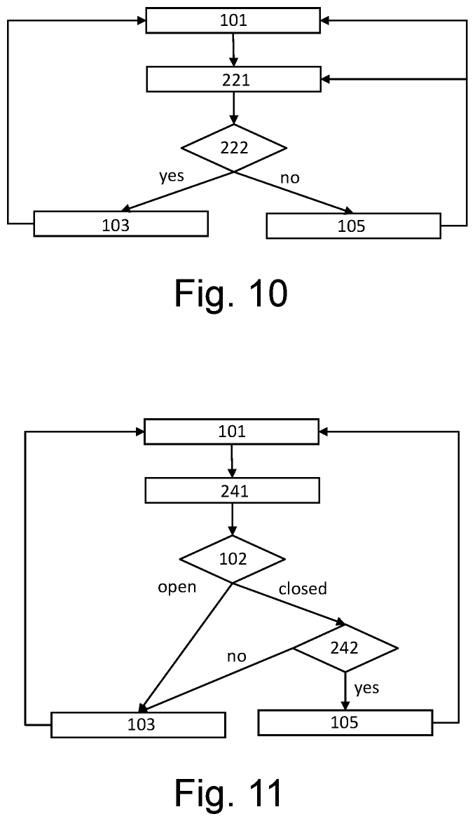

An eighth embodiment of the method of controlling access to one or more lighting devices is shown in FIG. 10. The method may be performed by the controller 1 of FIG. 1, for example. The eighth embodiment of FIG. 10 is an extension of the first embodiment of FIG. 3.

Step 101 comprises receiving a sensor signal from a door sensor. The sensor signal is indicative of a door status. The door status is indicative of whether a door to a room is open or closed. The one or more lighting devices are located in this room.

A step 221 comprises determining how long the current door status has been the same. A step 222 comprises determining, based on the current status and the time this door status has been the same, whether the door is detected to be open and the door has been open for at least a predetermined amount of time. If so, step 103 is performed. If not step, 105 is performed.

Step 103 comprises granting a first set of a plurality of users access to control the first function the one or more lighting devices in the room. Step 105 comprises granting a second set of one or more users access to control at least the first function of the one or more lighting devices in the room. The second set is a subset of the first set. Step 105 further comprises denying one or more other users of the first set access to control at least the first function of the one or more lighting devices in the room.

Thus, in the embodiment of FIG. 10, a time-out is applied on the door sensor state and access restrictions for the lighting devices, and optionally accessories, in the room remain valid for this timeout. This prevents granting access to any user in between opening and closing the door.

Step 101 is repeated after step 103 or step 105 has been performed, and the method then proceeds as shown in FIG. 10. Additionally, one or more steps of one or more of the embodiments of FIGS. 4-9, 11 may be added to the embodiment of FIG. 10. For example, when the embodiments of FIGS. 9 and 10 are combined, after authorization of the user of rent-out flex office, the user has a fixed amount of time authorization which is independent on the door position. This can be useful if the person would like to go out of the rented room, e.g. to get a coffee. Although the door is open and the user is away, the user remains the only person authorized to access the lighting device(s) in the rented room.

A ninth embodiment of the method of controlling access to one or more lighting devices is shown in FIG. 11. The method may be performed by the controller 1 of FIG. 1, for example. The eighth embodiment of FIG. 11 is an extension of the first embodiment of FIG. 3.

Step 101 comprises receiving a sensor signal from a door sensor. The sensor signal is indicative of a door status. The door status is indicative of whether a door to a room is open or closed. The one or more lighting devices are located in this room.

A step 241 comprises determining whether a human is present in this room. Step 102 comprises determining, based on the door status indicated in the sensor signal received in step 101, whether the door is open or closed and performing step 103 if the door is detected to be open and a step 242 if the door is detected to be open. Step 103 comprises granting a first set of a plurality of users access to control the first function the one or more lighting devices in the room.

A step 242 comprises checking whether a human was determined to be present in the room in step 241. If not, step 103 is performed even though the door is closed. If so, step 105 is performed. Step 105 comprises granting a second set of one or more users access to control at least the first function of the one or more lighting devices in the room. The second set is a subset of the first set. Step 105 further comprises denying one or more other users of the first set access to control at least the first function of the one or more lighting devices in the room.

In other words, other users may control the lighting devices in the room when the door is closed and if (lately) no presence is detected by a presence or motion sensor. The device that acts as door sensor may also be able to sense presence or motion or a presence or motion sensor may be installed in the room in addition to the door sensor, for example.

Step 101 is repeated after step 103 or step 105 has been performed, and the method then proceeds as shown in FIG. 10. Additionally, one or more steps of one or more of the embodiments of FIGS. 4-10 may be added to the embodiment of FIG. 11.

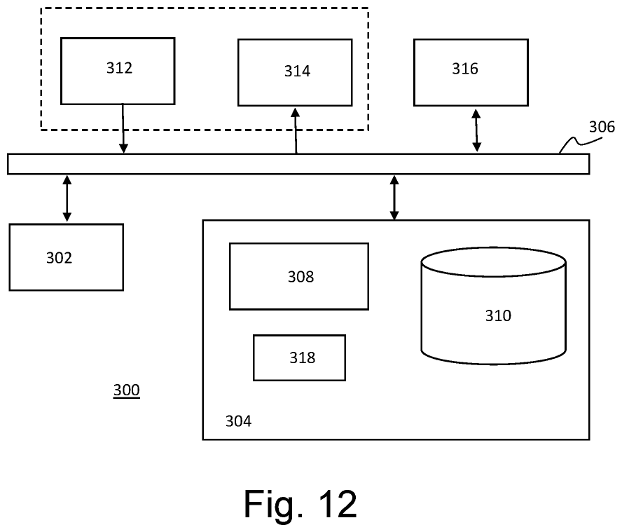

FIG. 12 depicts a block diagram illustrating an exemplary data processing system that may perform the method as described with reference to FIGS. 3-11.

As shown in FIG. 12, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 12 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 12, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 12) that can facilitate execution of the application 318. The application 318, being implemented in the form of executable program code, can be executed by the data processing system 300, e.g., by the processor 302.

Responsive to executing the application, the data processing system 300 may be configured to perform one or more operations or method steps described herein.

FIG. 12 shows the input device 312 and the output device 314 as being separate from the network adapter 316. However, additionally or alternatively, input may be received via the network adapter 316 and output be transmitted via the network adapter 316. For example, the data processing system 300 may be a cloud server. In this case, the input may be received from and the output may be transmitted to a user device that acts as a terminal.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling access to one or more lighting devices, said system comprising:
at least one input interface;
at least one processor configured to:
receive, via said at least one input interface, a sensor signal from a door sensor indicative of a door status, said door status being indicative of whether a door to a room is detected to be open or closed,
grant a first set of a plurality of users access to control at least a first function of said one or more lighting devices in said room while said door is detected to be open, and
grant a second set of one or more users access to control at least said first function of said one or more lighting devices in said room while said door is detected to be closed, said second set being a subset of said first set, and deny one or more other users of said first set access to control at least said first function of said one or more lighting devices in said room while said door is detected to be closed.

2. A system as claimed in claim 1, wherein said at least one processor is configured to allow or prevent a user device from controlling said one or more lighting devices in said room in dependence on an identifier of said user of said user device and said door status, said user device being allowed to control said one or more lighting devices if said identifier is included in a plurality of first identifiers of said first set of users and said door status indicates that said door is open or if said identifier is included in a plurality of second identifiers of said second set of users and said door status indicates that said door is closed.

3. A system as claimed in claim 2, wherein said system further comprises at least one control interface and said at least one processor is configured to forward, via said at least one control interface, a control command to at least one of said one or more lighting devices upon receiving said control command from said user device if said user device is allowed to control said one or more lighting devices.

4. A system as claimed in claim 2, wherein said at least one processor is configured to:
determine whether said user device is connected to a same network as said system,
allow said user device to control said one or more lighting devices in said room if said user device is determined to be connected to the same network as said system, and
prevent said user device from controlling said one or more lighting devices in said room if said user device is determined to be connected to a different network than said system.

5. A system as claimed in claim 2, wherein said at least one processor is configured to provide a user interface on said user device based on said identifier of said user and said door status, said user interface indicating that said user can control said one or more lighting devices and/or obtain information relating to said one or more lighting devices if said identifier is included in said plurality of first identifiers of said first set of users and said door status indicates that said door is open or if said identifier is included in said plurality of second identifiers of said second set of users and said door status indicates that said door is closed.

6. A system as claimed in claim 1, wherein said at least one processor is configured to:
grant said first set of users access to obtain current status information of said one or more lighting devices in said room while said door is detected to be open, and
grant said second set of one or more users access to obtain said current status information of said one or more lighting devices in said room while said door is detected to be closed and deny said one or more other users access to obtain said current status information of said one or more lighting devices in said room while said door is detected to be closed.

7. A system as claimed in claim 1, wherein said at least one processor is configured to:
grant said first set of users access to obtain first event information on first events related to said one or more lighting devices in said room, said first events occurring while said door is detected to be open, and
grant said second set of one or more users access to obtain second event information on second events related to said one or more lighting devices in said room and deny said one or more other users access to obtain said second event information, said second events occurring while said door is detected to be closed.

8. A system as claimed in claim 1, wherein said at least one processor is configured to prevent one or more automated routines from controlling said one or more lighting devices in said room while said door is detected to be closed.

9. A system as claimed in claim 8, wherein said at least one processor is configured to prevent all automated routines from controlling said one or more lighting devices in said room while said door is detected to be closed or prevent all automated routines not associated with anyone from said second set of users from controlling said one or more lighting devices in said room while said door is detected to be closed.

10. A system as claimed in claim 1, wherein said at least one processor is configured to:
detect a local user device in proximity of said door
obtain an identifier of a user of said local user device, and
store said identifier of said user in a memory in relation to said second set of users to include said user in said second set of users.

11. A system as claimed in claim 1, wherein said at least one processor is configured to:
grant said first set of users access to control at least said first function of said one or more lighting devices in said room while said door is detected to be open and said door has been open for at least a predetermined amount of time, and
deny said one or more other users of said first set access to control at least said first function of said one or more lighting devices in said room while said door is detected to be open and said door has not been open for at least said predetermined amount of time.

12. A system as claimed in claim 1, wherein said at least one processor is configured to:
detect whether a human is present in said room,
grant said first set of users access to control at least said first function of said one or more lighting devices in said room while said door is detected to be closed and no human is detected to be present in said room, and
deny said one or more other users of said first set access to control at least said first function of said one or more lighting devices in said room while said door is detected to be closed and a human is detected to be present in said room.

13. A system as claimed in claim 1, further comprising the door sensor.

14. A method of controlling access to one or more lighting devices, said method comprising:
receiving a sensor signal from a door sensor indicative of a door status, said door status being indicative of whether a door to a room is detected to be open or closed;
granting a first set of a plurality of users access to control at least a first function said one or more lighting devices in said room while said door is detected to be open; and
granting a second set of one or more users access to control at least said first function of said one or more lighting devices in said room while said door is detected to be closed, said second set being a subset of said first set, and denying one or more other users of said first set access to control at least said first function of said one or more lighting devices in said room while said door is detected to be closed.

15. A computer program product for a computing device, the computer program product comprising computer program code to perform the method of claim 14 when the computer program product is run on a processing unit of the computing device.
